(19) United States
(12) Patent Application Publication
(10) Pub. No.: US 2025/0313746 A1
(43) Pub. Date: Oct. 9, 2025

(54) POLYMER SYSTEMS FOR SUBTERRANEAN ENERGY STORAGE

(71) Applicant: Halliburton Energy Services, Inc., Houston, TX (US)

(72) Inventor: Paul J Jones, Houston, TX (US)

(73) Assignee: Halliburton Energy Services, Inc., Houston, TX (US)

(21) Appl. No.: 18/923,878

(22) Filed: Oct. 23, 2024

Related U.S. Application Data
(60) Provisional application No. 63/631,714, filed on Apr. 9, 2024.

(51) Int. Cl. C09K 8/70; C09K 8/88

(52) U.S. Cl. CPC C09K 8/70; C09K 8/882

(57) ABSTRACT

A method may include: introducing a resin modified cement slurry into a wellbore penetrating a subterranean formation, the subterranean formation comprising a caprock and a carbon dioxide injection zone, the resin modified cement slurry comprising: a resin; a hardener; a hydraulic cement; and water; and setting the resin modified cement slurry to form a set cement wherein the set cement forms a carbonation-resistant barrier in the carbon dioxide injection zone in the subterranean formation.

### BACKGROUND

Renewable energy sources such as wind and solar produce energy intermittently during windy and sunny periods. Energy demand from the electrical grid also occurs cyclically with periods of relatively higher loads and period of relatively lower loads. Operators of the electrical grid must balance the energy demand from customers with the energy generation from producers such that the grid remains synchronized and stable. When there is a discrepancy between renewable energy production and energy demand, such as if more energy is being generated than consumed, the excess production may be wasted leading to inefficiencies.

Grid scale energy storage techniques are used to add generation capacity during periods of high demand and recharge during periods of low demand to smooth the gaps between energy production cycles from renewables and demand cycles. One grid scale energy storage technique is pumped hydro energy storage where water is pumped to a reservoir at an elevated location and released as needed to generate energy. Pumped hydro energy storage is geographically limited to areas with the topographic features required for construction of the reservoir.

Another emerging technology for grid scale energy storage is pumped geo-mechanical storage of renewable energy. In this technique, water is pumped using a renewable energy source into a suitable geological formation thereby pressurizing the water and trapping the water within the geological formation. The geological formation includes a relatively horizontal fracture which has a permeable zone into which the water can flow and is usually surrounded by less permeable or impermeable zones which reduce leak off of the water. When required, the pressurized water is flowed back out of the geological formation and through a turbine to generate energy. In practice, the fracture which stores the water is not impermeable and a portion of the water pumped into the fracture migrates to other regions of the geological formation which reduces the cyclic efficiency pumped geo-mechanical storage system. Leak off may occur at any portion of the fracture but may be particularly pronounced at the fracture tip. The leak off may increase over time with cyclic pumping of water into the fracture tip.

### BRIEF DESCRIPTION OF THE DRAWINGS

These drawings illustrate certain aspects of some of the embodiments of the present disclosure and should not be used to limit or define the disclosure.

FIG. 1a illustrates introducing a fluid into a fracture, in accordance with some embodiments of the present disclosure.

FIG. 1b illustrates producing electricity from fluid from a fracture, in accordance with some embodiments of the present disclosure.

FIG. 2 illustrates a system for the preparation of a fracturing fluid train, in accordance with some embodiments of the present disclosure.

FIG. 3 illustrates surface equipment for placement of a fracturing fluid train containing a resin pill, in accordance with some embodiments of the present disclosure.

### DETAILED DESCRIPTION

The present disclosure relates to systems and methods of energy storage using pumped geo-mechanical storage in a subterranean formation. More particularly, certain embodiments of the present disclosure are directed to systems and methods of introducing a fluid comprising a resin capable of undergoing a ring-opening metathesis polymerization (ROMP) reaction into to subterranean formation suitable for geo-mechanical energy storage.

As discussed above, techniques for pumped geo-mechanical energy storage comprise introducing a fluid, oftentimes water, from a surface into a subterranean formation comprising a subterranean strata capable of containing the fluid. Typically, a wellbore penetrating the subterranean formation into the strata is utilized, where the wellbore includes casing which is cemented in place within the subterranean formation. The wellbore typically includes a wellhead mounted at surface location where the wellhead is in fluid communication with the strata through an interior of the wellbore. The wellhead allows for the fluid to be pumped to one or more fractures in the strata in a controlled manner and allows for the production of the fluid from the one or more fractures. The wellbore may also include completion components including, but not limited to, tubing strings, liners, packers, screens, valves, blow out preventers, and other wellbore competition equipment to enable geo-mechanical energy storage. In embodiments, the wellbore includes a barefoot completion, an open hole completion, an open hole, a liner completion, and/or a cased hole completion.

The strata may contain one or more fractures into which the fluid flows. As the fluid flows into the strata, pressure builds within the strata and the pressurized fluid elastically deforms the rock comprising the strata causing the subterranean formation to lift and displace. The pressurized fluid stores potential mechanical energy which can be later released as desired. Once the desired volume of the fluid is introduced into the strata, the flow is stopped, and the wellbore is isolated using a valve. The clastic deformation of rock allows for relatively large volumes of water to flow into the fractures, oftentimes many times the volume of the initial fracture to the final volume of the fracture. When production of electricity is desired, the valve isolating the wellbore is opened and the fluid is produced through the wellhead. The fluid may be under relatively high pressure because of the overburden pressure, also known as lithostatic pressure or vertical stress, in the subterranean formation caused by the weight of the overlying rocks and sediments squeezing the strata containing the one or more fluid-filled fractures. The high-pressure fluid is introduced into a turbine or other equipment capable of using the high-pressure fluid to generate electricity.

One challenge with pumped geo-mechanical energy storage is that fluid does not remain in the strata. The fluid may “leak off” from the fractures into other parts of the strata thereby reducing the volume of fluid available to produce electricity from. The leak off may be due to several reasons, including that the fluid may flow through the matrix of the rock within the strata and cyclic pumping may increase the length and size of the strata.

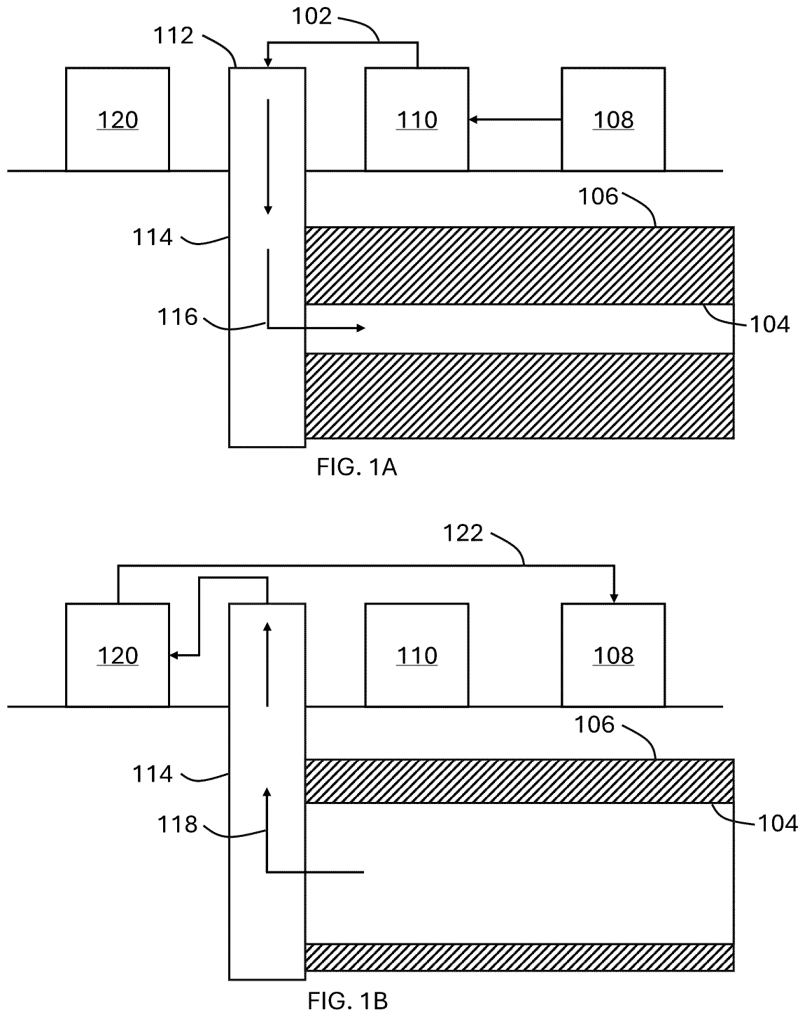

FIG. 1A illustrates introducing a fluid 102 into a fracture 104 within a strata 106. As shown in FIG. 1A, fluid source 108 provides fluid 102 to pump 110. Fluid source 108 may include any suitable fluid source such as a pond, lake, stream, ocean, pool, and the like which can provide a fluid, such as water, to pump 110 in volumes great enough to eventually produce and generate electricity from. Pump 110 introduces fluid 102 into wellhead 112 which is fluidically connected to wellbore 114. Fluid 102 flows through wellbore 114 to fracture 104 as indicated by arrow 116. Fracture 104 contains a cured ROMP resin which may reduce the leak off rate of fluid 102 from fracture 104. Fluid 102 is pumped into fracture 104 and the wellbore is isolated, using a valve associated with wellhead 112, for example, when a desired volume of fluid 102 has been pumped. In embodiments, pump 110 is powered by renewable energy sources such as solar, wind, hydroelectric, geothermal, wave energy, and hydrogen, for example.

FIG. 1B illustrates producing electricity from fluid 102. As shown in FIG. 1B, fracture 104 is larger than in FIG. 1A due to the volume of fluid 102 therein. When electricity production is desired, the valve is opened and fluid 102 is allowed to flow from fracture 104 to wellhead 112 as indicated by arrow 118. Fluid 102 flows through wellhead 112 to electricity generating equipment 120, which may include a turbine, to generate electricity. The fluid may then be returned to fluid source 108 by line 122.

To generate one or more fractures within the strata, a fracturing fluid train is pumped into the strata using pumping equipment (e.g. positive displacement pumps, centrifugal pumps, hydraulic pumps, piston pumps) at elevated pressure above the fracture gradient of the strata which causes the rock within the strata to split and fracture. In embodiments, the fracturing fluid train includes a resin pill containing a resin capable of undergoing a ring-opening metathesis polymerization (ROMP). In embodiments, the resin pill is the first fluid introduced into the strata to initiate the fracturing process. In further embodiments, a pad fluid and/or a pre-pad fluid is introduced ahead of the resin pill to initiate the fracturing process. In further embodiments, the fracturing fluid train includes a displacement pill capable of displacing the resin pill into the strata and one or more fractures therein. In further embodiments, the fracturing fluid train further includes a water-based fracturing fluid introduced into the strata after the resin pill.

In embodiments, the components of the fracturing fluid train, including the resin pill, and optionally if used, the pad fluid/pre-pad fluid, water-based fracturing fluid, and displacement are individually prepared and pumped in succession. The components of the fluids comprising the fracturing fluid train are mixed by any suitable methods including mixing in drums, barrels, tubs, bins, jet mixers, re-circulating mixers, and/or batch mixers. In further embodiments, the components of the resin pill are mixed in a y-pipe and/or an impinging mixer.

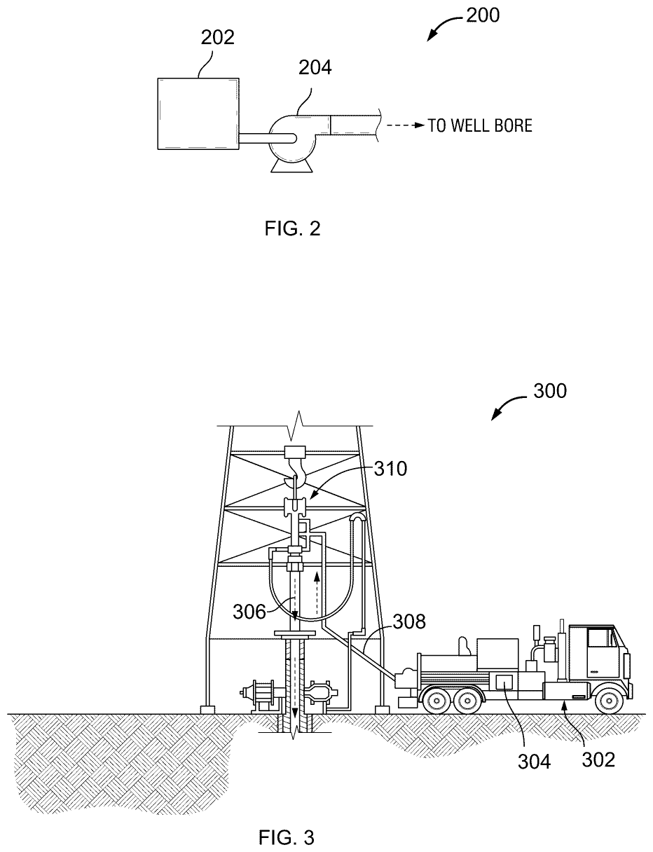

Referring now to FIG. 2 which illustrates a system 200 for the preparation of a fracturing fluid train containing a resin pill containing a resin capable of undergoing a ring-opening metathesis polymerization (ROMP) and introduction into a wellbore in accordance with some embodiments. As shown, the fracturing fluid train containing a resin pill containing a resin may be mixed in mixing equipment 202, such as a jet mixer, re-circulating mixer, impingement mixer, or a batch mixer, for example, and then pumped via pumping equipment 204 to the wellbore. In some examples, the mixing equipment 202 and the pumping equipment 204 may be disposed on one or more blenders and/or pump trucks. In embodiments, the components of the resin pill including a cycloalkene and a transition metal compound catalyst are blended to form the resin pill and the pumping equipment 204 is introduced into the wellbore. In embodiments, an impingement mixer is utilized to mix a suspension of the transition metal compound catalyst into the resin.

An example fracturing technique using fracturing fluid train containing a resin pill containing a resin capable of undergoing a ring-opening metathesis polymerization (ROMP) in accordance with some embodiments. FIG. 3 illustrates surface equipment 300 that may be used in the placement of the fracturing fluid train containing a resin pill in accordance with certain examples. It should be noted that while FIG. 3 generally depicts a land-based operation, the principles described herein are equally applicable to subsea operations that employ floating or sea-based platforms and rigs, without departing from the scope of the disclosure. As illustrated by FIG. 3, the surface equipment 300 may include a fracturing unit 302, which may include one or more fracturing trucks. The fracturing unit 302 may include mixing equipment 304 and pumping equipment 204 (e.g., FIG. 2). Fracturing unit 302, or multiple fracturing units 302, may pump fracturing fluid train containing a resin pill 306 through a feed pipe 308 and to a well head 310 which conveys the resin containing fracturing fluid train containing a resin pill 306 downhole.

A resin pill may include a resin that can undergo a ring-opening metathesis polymerization (ROMP) reaction. Resin molecules that undergo ROMP may polymerize by forming new carbon-carbon bonds between molecules. Once the polymerization reaction is initiated, the reaction may proceed rapidly to transform the resin pill from a liquid to a solid. During the reaction, heat may be released which may raise the temperature of the resin pill, however, the heat generated may not be sufficient to char or degrade the final set product. The resin in the resin pill may be pumpable below 38° C. (100° F.) without additional solvents present. Further, the resin may have a density greater than water and a viscosity that may be ideal for deep penetration into channels, vugs, and other defects in the strata.

The resin included in the resin pill may include a cycloalkene, which may be a cycloalkadiene, that may undergo a ring-opening metathesis polymerization reaction transforming the resin pill into a hardened mass. The cycloalkene may have no aromatic character. The cycloalkene may include, but is not limited to cyclopentadiene, dicyclopentadiene, tricyclopentadiene, cyclobutadiene, cyclohexadiene, terpinene, norbornadiene, isomers thereof, and combinations thereof. The cycloalkene may also be substituted or unsubstituted cycloalkadienes. Substituted cycloalkadienes may be substituted with a hydrocarbyl group or any other suitable organic functional group. In embodiments the resin pill includes combinations of resins such as, for example, 70 vol. % to 90 vol. % dicyclopentadiene and 10 vol. % to 30 vol. % tricyclopentadiene.

The cycloalkene may be present at a point in a range of about 50 wt. % to about 99.5 wt. % of the resin pill. Alternatively, the cycloalkene may be present at a point in a range of about 50 wt. % to about 60 wt. %, at a point in a range of about 60 wt. % to about 70 wt. %, at a point in a range of about 70 wt. % to about 80 wt. %, at a point in a range of about 80 wt. % to about 90 wt. %, at a point in a range of about 90 wt. % to about 99.5 wt. %. or any ranges therebetween.

The resin pill may include a transition metal compound catalyst where the transition metal compound catalyst may include a substituted or unsubstituted metal carbene compound comprising a transition metal and an organic backbone. The transition metal catalyst acts as an activator to crosslink the rein to form a cured resin. Some non-limiting examples of the transition metal compound catalyst may include, but not are limited to a Grubbs Catalyst® and Schrock catalysts. The Grubbs Catalyst® may include ruthenium alkylidene or osmium alkylidene and Schrock catalyst may include molybdenum. Selection of a transition metal compound catalyst may affect the polymerization rate. The transition metal compound catalyst may be present in the resin pills at a point in a range of about 0.001 wt. % to about 20 wt. %. Alternatively, the transition metal compound catalyst may be present at a point in a range of about 0.001 wt. % to about 1 wt. %, at a point in a range of about 1 wt. % to about 5 wt. %, at a point in a range of about 5 wt. % to about 10 wt. %, at a point in a range of about 10 wt. % to about 15 wt. %, at a point in a range of about 15 wt. % to about 20 wt. %, or any ranges therebetween. Alternatively, the resin and the transition metal compound catalyst concentrations may be expressed as a relative mass ratios. For example, the resin and the transition metal compound catalyst may be present in the resin pill in a mass ratio of about 50:1 to about 10000:1 resin to transition metal compound catalyst. Alternatively, the resin and transition metal compound catalyst may also be present in mass ratios of about 50:1 to about 100:1, about 100:1 to about 500:1, about 500:1 to about 1000:1, about 1000:1 to about 2000:1, about to 2000:1 to about 3000:1, about 3000:1 to about 4000:1, about 4000:1 to about 5000:1, about 5000:1 to about 6000:1, about 6000:1 to about 7000:1, about 7000:1 to about 8000:1, about 8000:1 to about 9000:1, about 9000:1 to about 10000:1 or any mass ratios therebetween of the resin to the transition metal compound catalyst. Alternatively, the transition metal compound catalyst may be suspended in a mineral oil suspension, or any suitable suspension medium. For example, the suspension medium may be present in the transition metal compound catalyst suspension in an amount of about 90% to 99% of the transition metal compound catalyst suspension. Alternatively, the suspension medium may be present in amount of about 90% to about 92%, about 93% to about 95%, and about 96% to about 99%. The resin and the transition metal compound catalyst suspension concentrations may be expressed as a relative mass ratios. For example, the resin and the transition metal compound catalyst suspension may be present in the resin pill in a mass ratio of about 50:1 resin to transition metal compound catalyst suspension. Alternatively, the resin and transition metal compound catalyst suspension may also be present in mass ratios of about 20:1, about 30:1, about 40:1, about 60:1, about 70:1, or about 80:1, or any mass ratios therebetween of the resin to the transition metal compound catalyst suspension. Specific examples of suitable transition metal compound catalysts will be described in detail below.

The transition metal compound catalyst may have the general chemical structure depicted in Structure 1. M may be either ruthenium or osmium. R and R1 may be independently selected from hydrogen, C2-C20 alkenyl, C2-C20 alkynyl, C2-C20 alkyl, aryl, C1-C20 carboxylate, C1-C20 alkoxy, C2-C20 alkenyloxy, C2-C20 alkynyloxy, aryloxy, C2-C20 alkoxycarbonyl, C1-C20 alkylthio, C1-C20 alkylsulfonyl or C1-C20 alkyl sulfinyl. The selected R and R1 may be optionally substituted with C1-C5 alkyl, halogen, C1-C5 alkoxy or with a phenyl group further optionally substituted with halogen, C1-C5 alkyl or C1-C5 alkoxy. X and X1 may be the same or different and may be any suitable anionic ligand. L and L1 may any suitable neutral electron donor.

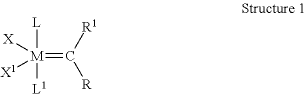

The transition metal compound catalyst may also have the general chemical structure depicted in Structure 2. M may be either ruthenium or osmium. R and R1 may be independently selected from hydrogen, C2-C20 alkenyl, C2-C20 alkynyl, C2-C20 alkyl, aryl, C1-C20 carboxylate, C1-C20 alkoxy, C2-C20 alkenyloxy, C2-C20 alkynyloxy, aryloxy, C2-C20 alkoxycarbonyl, C1-C20 alkylthio, C1-C20 alkylsulfonyl or C1-C20 alkyl sulfinyl. The selected R and R1 may optionally be substituted with C1-C5 alkyl, halogen, C1-C5 alkoxy or with a phenyl group further optionally substituted with halogen, C1-C5 alkyl or C1-C5 alkoxy. X and X1 groups may be the same or different and may be any suitable anionic ligand. L2, L3, and LA may be the same or different, and may be any suitable neutral electron donor ligand, wherein at least one L2, L3, and L4 may be an N-heterocyclic (NHC) carbene ligand as described below.

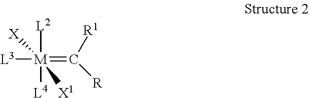

The transition metal compound catalyst may also have the general chemical structure depicted in Structure 3. M may be either ruthenium or osmium. R and R1 may be independently selected from hydrogen, C2-C20 alkenyl, C2-C20 alkynyl, C2-C20 alkyl, aryl, C1-C20 carboxylate, C1-C20 alkoxy, C2-C20 alkenyloxy, C2-C20 alkynyloxy, aryloxy, C2-C20 alkoxycarbonyl, C1-C20 alkylthio, C1-C20 alkylsulfonyl or C1-C20 alkyl sulfinyl. The selected R and R1 may optionally be substituted with C1-C5 alkyl, halogen, C1-C5 alkoxy or with a phenyl group further optionally substituted with halogen, C1-C5 alkyl or C1-C5 alkoxy. X and X1 may be the same or different and may be any suitable anionic ligand. NHC may be any N-heterocyclic carbene (NHC) ligand as described below.

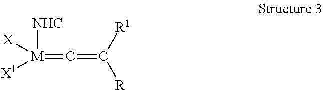

The transition metal compound catalyst may also have the general chemical structure depicted in Structure 4. M may be either ruthenium or osmium. R and R1 may be independently selected from hydrogen, C2-C20 alkenyl, C2-C20 alkynyl, C2-C20 alkyl, aryl, C1-C20 carboxylate, C1-C20 alkoxy, C2-C20 alkenyloxy, C2-C20 alkynyloxy, aryloxy, C2-C20 alkoxycarbonyl, C1-C20 alkylthio, C1-C20 alkylsulfonyl or C1-C20 alkyl sulfinyl. The selected R and R1 may optionally be substituted with C1-C5 alkyl, halogen, C1-C5 alkoxy or with a phenyl group further optionally substituted with halogen, C1-C5 alkyl or C1-C5 alkoxy. X and X1 may be the same or different and may be any suitable anionic ligand. NHC may be any N-heterocyclic carbene (NHC) ligand as described below.

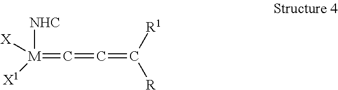

The transition metal compound catalysts of Structures 2-4 may further include an N-heterocyclic carbene (NHC) ligand. The NHC ligands may include 4-membered NHC and 5-membered NHC where the NHC ligand may attach to one coordination site of the transition metal compound catalyst. Structures 5-9 are exemplary structures of NHC ligands.

The NHC ligand may be a 4-membered N-heterocyclic carbene ligand. An exemplary structure of 4-membered carbene ligand is depicted in Structure 5. In the following structure, iPr is an isopropyl group.

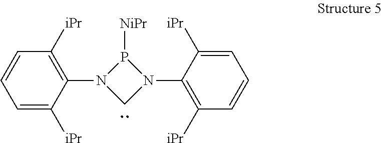

The NHC ligand may also be a 5-membered N-heterocyclic carbene ligand. An exemplary structure of 5-membered carbene ligands is depicted in Structure 6 and Structure 7. R1 and R² may be independently selected from 2,4,6-(Me)3C6H2, 2,6-(iPr)2C6H3, cyclohexyl, tert-butyl, 1-adamantyl.

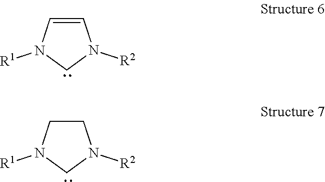

The NHC ligand may be a 5-membered N-heterocyclic carbene ligand. Another exemplary structure of a 5-membered carbene ligand is depicted in Structure 8. R¹ and R² may be equivalent groups and may be selected from (CH₂)ₙ where n may be 4-7 and 12.

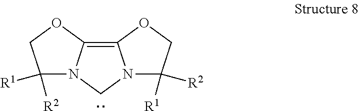

The NHC ligand may be a 5-membered N-heterocyclic carbene ligand. An exemplary structure of 5-membered carbene ligand is depicted in Structure 9. R may be selected between hydrogen and tert-butyl.

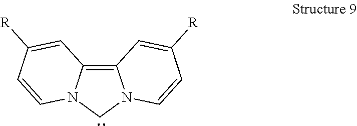

The resin pill may further include solvents. Suitable examples of solvents may include, but are not limited to, an alcohol (e.g., isopropyl alcohol, methanol, butanol, and the like); a glycol (e.g., ethylene glycol, propylene glycol, and the like); a glycol ether (e.g., ethyleneglycol monomethyl ether, ethylene glycol monobutylether, and the like); a polyether (e.g., polypropylene glycol); and any combination thereof. Suitable example of solvents may also include but are not limited to hydrocarbon fluids (e.g. base oils, diesel oil, mineral oil, cyclohexane).

The resin pill may further include additional additives. Such additional additives can include, without limitation, particulate materials, fibrous materials, bridging agents, weighting agents, gravel, corrosion inhibitors, catalysts, clay control stabilizers, biocides, bactericides, friction reducers, gases, surfactants, solubilizers, salts, scale inhibitors, foaming agents, anti-foaming agents, iron control agents, and the like.

In embodiments, the displacement pill includes an aqueous base fluid and a gelling agent polymer which may be optionally crosslinked. The displacement pill may further include bridging particles, including graded sand, graded salt particulate, or sized calcium carbonate particulate. In embodiments, the displacement pill includes 100 to 150 lbs/1000 gal of gelling agent. In embodiments the gelling agent includes derivatized hydroxyethylcellulose (“HEC”). HEC polymer solutions do not form rigid gels, but control fluid loss by a viscosity-regulated or filtration mechanism. In further embodiments, the displacement fluid includes a gelling agent such as xanthan, guar, guar derivatives, carboxymethylhydroxyethylcellulose (“CMHEC”), starch, viscoelastic surfactants, and combinations thereof.

In embodiments, the displacement pill includes crosslinked gel. Crosslinking the gelling agent polymer creates a gel structure that can support solids as well as provide fluid-loss control. Further, crosslinked fluid-loss control pills have demonstrated that they require relatively limited invasion of the formation face to be fully effective. To crosslink the gelling agent polymers, a suitable crosslinking agent that comprises polyvalent metal ions is utilized such as aluminum, boron, titanium, and/or zirconium.

In embodiments, the displacement pill includes graft copolymers of a hydroxyalkyl cellulose, guar, or hydroxypropyl guar that are prepared by a redox reaction with vinyl phosphonic acid. The gel is formed by hydrating the graft copolymer in an aqueous solution containing at least a trace amount of at least one divalent cation. The gel is crosslinked by the addition of a Lewis base or Bronsted-Lowrey base so that pH of the aqueous solution is adjusted from slightly acidic to slightly basic. Preferably, the chosen base is substantially free of polyvalent metal ions. The resulting crosslinked gel demonstrates shear-thinning and rehealing properties that provide relatively easy pumping, while the rehealed gel provides good fluid-loss control upon placement. This gel can be broken by reducing the pH of the fluid or by the use of oxidizers.

The following statements may describe certain embodiments of the disclosure but should be read to be limiting to any particular embodiment.
Embodiment 1. A method comprising: introducing into a subterranean strata a resin pill comprising: a resin comprising a cycloalkene; and a transition metal compound catalyst, wherein the subterranean strata is capable of holding a fluid for geo-mechanical energy storage.
Embodiment 2. The method of embodiment 1, wherein the cycloalkene is selected from the group consisting of cyclopentadiene, dicyclopentadiene, tricyclopentadiene, cyclobutadiene, cyclobutadiene derivatives, cyclohexadiene, terpinene, norbornadiene, isomers thereof, and combinations thereof.
Embodiment 3. The method of any of embodiments 1-2, wherein the transition metal compound catalyst comprises a catalyst having a structure selected from the group consisting of:

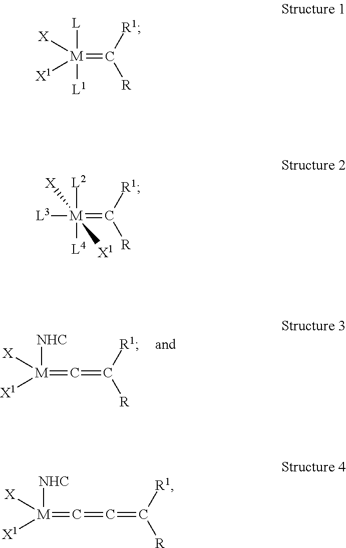

where M is ruthenium or osmium, R and R1 are independently selected from hydrogen, C2-C20 alkenyl, C2-C20 alkynyl, C2-C20 alkyl, aryl, C1-C20 carboxylate, C1-C20 alkoxy, C2-C20 alkenyloxy, C2-C20 alkynyloxy, aryloxy, C2-C20 alkoxycarbonyl, C1-C20 alkylthio, C1-C20 alkylsulfonyl or C1-C20 alkyl sulfinyl, X and X1 are each an anionic ligand, L and L1 are each a neutral electron donor, and NHC is an N-heterocyclic carbene ligand.
Embodiment 4. The method of any of embodiments 1-3, wherein R and R¹ are each substituted with a C1-C5 alkyl group, a halogen, a C1-C5 alkoxy group or a phenyl group, wherein the phenyl group is further unsubstituted or substituted with a C1-C5 alkyl group, a halogen, or a C1-C5 alkoxy group.
Embodiment 5. The method of any of embodiments 1-4, wherein the resin and the transition metal compound catalyst are present in a mass ratio of about 50:1 to about 10000:1 of the resin to the transition metal compound catalyst.
Embodiment 6. The method of any of embodiments 1-5, wherein the transition metal compound catalyst comprises a ruthenium carbene compound.
Embodiment 7. The method of any of embodiments 1-6, wherein the cycloalkene is a cycloalkene blend comprising about 70 vol. % to 90 vol. % dicyclopentadiene and 10 vol. % to 30 vol. % tricyclopentadiene, and wherein the transition metal compound catalyst comprises a ruthenium carbene compound.
Embodiment 8. The method of any of embodiments 1-7, further comprising preparing the resin pill by mixing the resin and the transition metal compound catalyst using mixing equipment.
Embodiment 9. The method of any of embodiments 1-8, wherein the mixing equipment comprises an impingement mixer is utilized to mix a suspension of the transition metal compound catalyst into the resin.
Embodiment 10. The method of any of embodiments 1-9, further comprising introducing a fracturing fluid into the strata prior to introducing the resin pill to form at least one fracture within the strata.
Embodiment 11. The method of any of embodiments 1-10, further comprising introducing a displacement pill into the strata to displace the fracturing fluid and the resin pill into the at least one fracture.
Embodiment 12. A method comprising: pumping a fluid, using pumping equipment, into a subterranean strata that is capable of holding a fluid for geo-mechanical energy storage, wherein the subterranean strata comprises a cured resin formed from a resin comprising a cycloalkene and a transition metal compound catalyst; storing the fluid in the subterranean strata under pressure; producing at least a portion of the fluid from the subterranean strata and introducing the portion of the fluid into a turbine; and producing energy from the turbine.
Embodiment 13. The method of embodiment 12, wherein the pumping equipment is powered by renewable energy.
Embodiment 14. The method of any of embodiments 12-13, wherein the renewable energy is derived from at least one energy source selected from the group consisting of solar energy, wind energy, hydroelectric energy, geothermal energy, wave energy, and hydrogen energy.
Embodiment 15. The method of any of embodiments 12-14, wherein the cycloalkene is selected from the group consisting of cyclopentadiene, dicyclopentadiene, tricyclopentadiene, cyclobutadiene, cyclobutadiene derivatives, cyclohexadiene, terpinene, norbornadiene, isomers thereof, and combinations thereof.
Embodiment 16. The method of any of embodiments 12-15, wherein the transition metal compound catalyst comprises a catalyst having a structure selected from the group consisting of:

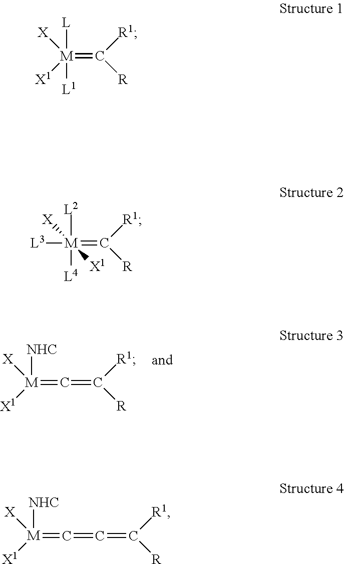

where M is ruthenium or osmium, R and R1 are independently selected from hydrogen, C2-C20 alkenyl, C2-C20 alkynyl, C2-C20 alkyl, aryl, C1-C20 carboxylate, C1-C20 alkoxy, C2-C20 alkenyloxy, C2-C20 alkynyloxy, aryloxy, C2-C20 alkoxycarbonyl, C1-C20 alkylthio, C1-C20 alkylsulfonyl or C1-C20 alkyl sulfinyl, X and X1 are each an anionic ligand, L and L1 are each a neutral electron donor, and NHC is an N-heterocyclic carbene ligand.
Embodiment 17. The method of any of embodiments 12-16, wherein R and R1 are each substituted with a C1-C5 alkyl group, a halogen, a C1-C5 alkoxy group or a phenyl group, wherein the phenyl group is further unsubstituted or substituted with a C1-C5 alkyl group, a halogen, or a C1-C5 alkoxy group.
Embodiment 18. The method of any of embodiments 12-17, wherein the resin and the transition metal compound catalyst are present in a mass ratio of about 50:1 to about 10000:1 of the resin to the transition metal compound catalyst.
Embodiment 19. The method of any of embodiments 12-18, wherein the transition metal compound catalyst comprises a ruthenium carbene compound.
Embodiment 20. The method of any of embodiments 12-19, wherein the cycloalkene is a cycloalkene blend comprising about 70 vol. % to 90 vol. % dicyclopentadiene and 10 vol. % to 30 vol. % tricyclopentadiene, and wherein the transition metal compound catalyst comprises a ruthenium carbene compound.

Although the present disclosure and its advantages have been described in detail, it should be understood that various changes, substitutions, and alterations may be made herein without departing from the spirit and scope of the disclosure as defined by the appended claims. The preceding description provides various examples of the systems and methods of use disclosed herein which may contain different method steps and alternative combinations of components. It should be understood that, although individual examples may be discussed herein, the present disclosure covers all combinations of the disclosed examples, including, without limitation, the different component combinations, method step combinations, and properties of the system. It should be understood that the compositions and methods are described in terms of “comprising,” “containing,” or “including” various components or steps, the compositions and methods can also “consist essentially of” or “consist of” the various components and steps. Moreover, the indefinite articles “a” or “an,” as used in the claims, are defined herein to mean one or more than one of the elements that it introduces.

For the sake of brevity, only certain ranges are explicitly disclosed herein. However, ranges from any lower limit may be combined with any upper limit to recite a range not explicitly recited, as well as ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present examples are well adapted to attain the ends and advantages mentioned as well as those that are inherent therein. The particular examples disclosed above are illustrative only and may be modified and practiced in different but equivalent manners apparent to those skilled in the art having the benefit of the teachings herein. Although individual examples are discussed, the disclosure covers all combinations of all of the examples. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative examples disclosed above may be altered or modified and all such variations are considered within the scope and spirit of those examples. If there is any conflict in the usages of a word or term in this specification and one or more patent(s) or other documents that may be incorporated herein by reference, the definitions that are consistent with this specification should be adopted.

What is claimed is:

1. A method comprising:
introducing into a subterranean strata a resin pill comprising:
a resin comprising a cycloalkene; and
a transition metal compound catalyst,
wherein the subterranean strata is capable of holding a fluid for geo-mechanical energy storage.

2. The method of claim 1, wherein the cycloalkene is selected from the group consisting of cyclopentadiene, dicyclopentadiene, tricyclopentadiene, cyclobutadiene, cyclobutadiene derivatives, cyclohexadiene, terpinene, norbornadiene, isomers thereof, and combinations thereof.

3. The method of claim 1, wherein the transition metal compound catalyst comprises a catalyst having a structure selected from the group consisting of: 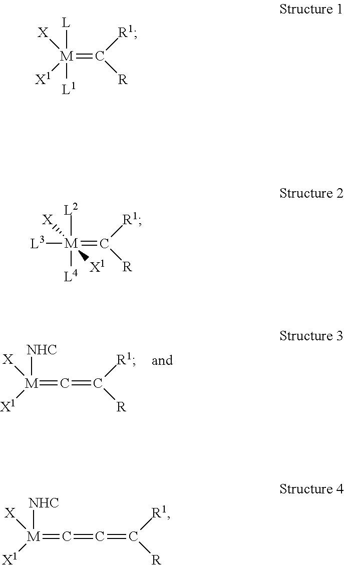
where M is ruthenium or osmium, R and R1 are independently selected from hydrogen, C2-C20 alkenyl, C2-C20 alkynyl, C2-C20 alkyl, aryl, C1-C20 carboxylate, C1-C20 alkoxy, C2-C20 alkenyloxy, C2-C20 alkynyloxy, aryloxy, C2-C20 alkoxycarbonyl, C1-C20 alkylthio, C1-C20 alkylsulfonyl or C1-C20 alkyl sulfinyl, X and X1 are each an anionic ligand, L and L1 are each a neutral electron donor, and NHC is an N-heterocyclic carbene ligand.

4. The method of claim 3, wherein R and R¹ are each substituted with a C1-C5 alkyl group, a halogen, a C1-C5 alkoxy group or a phenyl group, wherein the phenyl group is further unsubstituted or substituted with a C1-C5 alkyl group, a halogen, or a C1-C5 alkoxy group.

5. The method of claim 1, wherein the resin and the transition metal compound catalyst are present in a mass ratio of about 50:1 to about 10000:1 of the resin to the transition metal compound catalyst.

6. The method of claim 5, wherein the transition metal compound catalyst comprises a ruthenium carbene compound.

7. The method of claim 1, wherein the cycloalkene is a cycloalkene blend comprising about 70 vol. % to 90 vol. % dicyclopentadiene and 10 vol. % to 30 vol. % tricyclopentadiene, and wherein the transition metal compound catalyst comprises a ruthenium carbene compound.

8. The method of claim 1, further comprising preparing the resin pill by mixing the resin and the transition metal compound catalyst using mixing equipment.

9. The method of claim 8, wherein the mixing equipment comprises an impingement mixer is utilized to mix a suspension of the transition metal compound catalyst into the resin.

10. The method of claim 1, further comprising introducing a fracturing fluid into the strata prior to introducing the resin pill to form at least one fracture within the strata.

11. The method of claim 10, further comprising introducing a displacement pill into the strata to displace the fracturing fluid and the resin pill into the at least one fracture.

12. A method comprising:
pumping a fluid, using pumping equipment, into a subterranean strata that is capable of holding a fluid for geo-mechanical energy storage, wherein the subterranean strata comprises a cured resin formed from a resin comprising a cycloalkene and a transition metal compound catalyst;
storing the fluid in the subterranean strata under pressure;
producing at least a portion of the fluid from the subterranean strata and introducing the portion of the fluid into a turbine; and
producing energy from the turbine.

13. The method of claim 12, wherein the pumping equipment is powered by renewable energy.

14. The method of claim 13, wherein the renewable energy is derived from at least one energy source selected from the group consisting of solar energy, wind energy, hydroelectric energy, geothermal energy, wave energy, and hydrogen energy.

15. The method of claim 12, wherein the cycloalkene is selected from the group consisting of cyclopentadiene, dicyclopentadiene, tricyclopentadiene, cyclobutadiene, cyclobutadiene derivatives, cyclohexadiene, terpinene, norbornadiene, isomers thereof, and combinations thereof.

16. The method of claim 12, wherein the transition metal compound catalyst comprises a catalyst having a structure selected from the group consisting of: 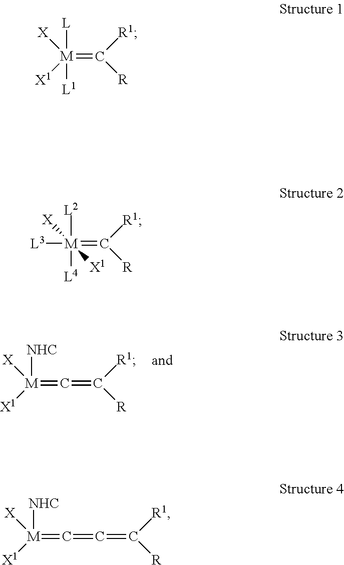
where M is ruthenium or osmium, R and R1 are independently selected from hydrogen, C2-C20 alkenyl, C2-C20 alkynyl, C2-C20 alkyl, aryl, C1-C20 carboxylate, C1-C20 alkoxy, C2-C20 alkenyloxy, C2-C20 alkynyloxy, aryloxy, C2-C20 alkoxycarbonyl, C1-C20 alkylthio, C1-C20 alkylsulfonyl or C1-C20 alkyl sulfinyl, X and X1 are each an anionic ligand, L and L1 are each a neutral electron donor, and NHC is an N-heterocyclic carbene ligand.

17. The method of claim 12, wherein R and R1 are each substituted with a C1-C5 alkyl group, a halogen, a C1-C5 alkoxy group or a phenyl group, wherein the phenyl group is further unsubstituted or substituted with a C1-C5 alkyl group, a halogen, or a C1-C5 alkoxy group.

18. The method of claim 12, wherein the resin and the transition metal compound catalyst are present in a mass ratio of about 50:1 to about 10000:1 of the resin to the transition metal compound catalyst.

19. The method of claim 18, wherein the transition metal compound catalyst comprises a ruthenium carbene compound.

20. The method of claim 12, wherein the cycloalkene is a cycloalkene blend comprising about 70 vol. % to 90 vol. % dicyclopentadiene and 10 vol. % to 30 vol. % tricyclopentadiene, and wherein the transition metal compound catalyst comprises a ruthenium carbene compound.
